(19) United States
(12) Patent Application Publication
(10) Pub. No.: US 2021/0159987 A1
(43) Pub. Date: May 27, 2021

(54) ENTANGLED, SPATIALLY DISTRIBUTED QUANTUM SENSOR NETWORK ENHANCED BY PRACTICAL QUANTUM REPEATERS

(71) Applicants: Arizona Board of Regents on Behalf of the University of Arizona, Tucson, AZ (US); General Dynamics Mission Systems, Inc., Fairfax, VA (US)

(72) Inventors: Zheshen Zhang, Tucson, AZ (US); Yi Xia, Tucson, AZ (US); Quntao Zhuang, Tucson, AZ (US); William Clark, Scottsdale, AZ (US)

(21) Appl. No.: 17/102,088

(22) Filed: Nov. 23, 2020

Related U.S. Application Data
(60) Provisional application No. 62/939,287, filed on Nov. 22, 2019.

(51) Int. Cl. H04B 10/70; H04B 10/29

(52) U.S. Cl. CPC H04B 10/70; H04B 10/29

(57) ABSTRACT

An entangled, spatially distributed, quantum sensor network enhanced by quantum repeaters includes a probe-state generator for generating M entangled light fields, where M is an integer greater than one. The quantum sensor network also includes M spatially distributed sensor modules that communicate with the probe-state generator to receive the M entangled light fields, respectively, and conduct a measurement therewith. The quantum sensor network also includes one or more quantum repeaters, each of which is (a) located in a propagation channel of a respective one of the entangled light fields to its corresponding sensor module from the probe-state generator, and (b) includes a plurality of quantum scissors to amplify the entangled light field to at least partly compensate for loss in the propagation channel.

### CROSS-REFERENCE TO RELATED APPLICATIONS

The present application claims the benefit of priority to U.S. Provisional Patent Application No. 62/939,287, filed Nov. 22, 2019. The entire contents of the aforementioned provisional patent application are incorporated herein by reference.

### BACKGROUND

Quantum sensing enables measurement sensitivity below the standard quantum limit (SQL). Such sub-SQL quantum sensing may utilize entanglement as a quantum resource. Entanglement-enhanced measurement sensitivity has been pursued in quantum-enhanced microscopy, local clock synchronization, and magnetic-field measurements. To date, most entanglement-enhanced sensing experiments have leveraged bipartite entanglement to enhance the measurement sensitivity of a single sensor.

Certain types of sensing applications require or benefit from collectively using multiple sensors as opposed to just a single sensor. Some of these sensing applications may benefit from entanglement-enhanced measurement sensitivity. However, in systems where the individual sensors are far apart, distribution of an entangled state from a central location to the individual sensors will be subject to transmission losses. For example, when a central source generates a set of light fields in a mutually entangled state, the light fields will be subject to photon losses during transmission from the central source to the respective sensors. These losses will compromise the degree of entanglement and thus diminish, or entirely eliminate, the entanglement-based enhancement.

Discrete-variable entanglement and continuous-variable entanglement are two different forms of entanglement applicable to light fields. In both cases, one or more properties of one light field is entangled with corresponding properties of at least one other light field. In discrete-variable entanglement of light fields, the entanglement is encoded in a discrete variable of the light fields, such as the photon number. In continuous-variable multipartite entanglement of light fields, the entanglement is encoded in a continuous variable of the light fields, such as phase and amplitude. Discrete- and continuous-variable entanglement of light fields are both degraded by photon loss. Bi-partite entanglement refers to entanglement of two subsystems, such as two light fields, whereas multi-partite entanglement refers to entanglement of more than two subsystems, such as three of more light fields.

### SUMMARY

In embodiments, an entangled, spatially distributed, quantum sensor network enhanced by quantum repeaters includes a probe-state generator configured to generate M entangled light fields, where M is an integer greater than one. The quantum sensor network also includes M spatially distributed sensor modules communicatively coupled with the probe-state generator to receive the M entangled light fields, respectively, and conduct a measurement therewith. The quantum sensor network also includes one or more quantum repeaters, each of which is (a) located in a propagation channel of a respective one of the entangled light fields to its corresponding sensor module from the probe-state generator, and (b) includes a plurality of quantum scissors to amplify the entangled light field to at least partly compensate for loss in the propagation channel.

In embodiments, a method for spatially distributed quantum sensing enhanced by quantum repeaters includes generating M entangled light fields at a central location, where M is an integer greater than one. The method also includes conducting, from M spatially distributed locations, a measurement with the M entangled light fields received from the central location via M propagation channels, respectively. The method also includes amplifying, in each of one or more of the propagation channels and with a quantum repeater, the entangled light field carried by the propagation channel to at least partly compensate for loss in the propagation channel.

### BRIEF DESCRIPTION OF THE DRAWINGS

FIG. 1 illustrates an entangled, spatially distributed quantum sensor network enhanced by quantum repeaters, according to an embodiment.

FIG. 2 illustrates a probe-state generator for generating light fields in continuous-variable entangled state, according to an embodiment.

FIG. 3 illustrates a quantum-scissor based quantum repeater for non-deterministic linear amplification of a light field, according to an embodiment.

FIG. 4 illustrates a quantum scissor for non-deterministic amplification of a light field, according to an embodiment.

FIG. 5 illustrates a method for spatially distributed quantum sensing enhanced by quantum repeaters, according to an embodiment.

### DETAILED DESCRIPTION OF THE EMBODIMENTS

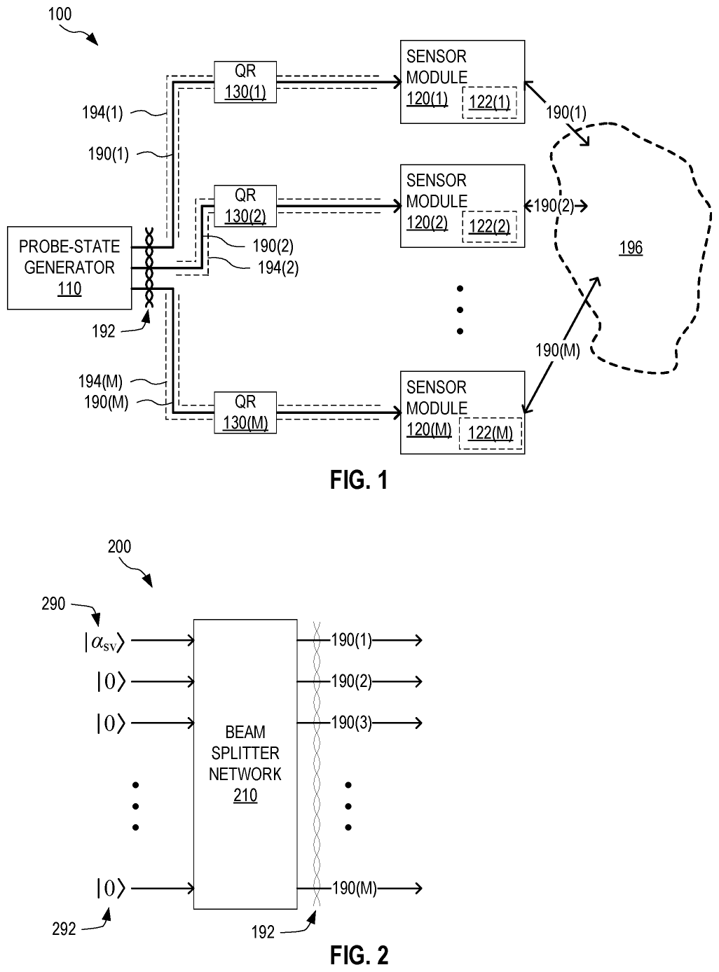

FIG. 1 illustrates one entangled, spatially distributed quantum sensor network 100 enhanced by quantum repeaters. Network 100 includes a probe-state generator 110 and a plurality of spatially distributed sensor modules 120(i), i=1, . . . M, wherein M is an integer greater than one. Probe-state generator 110 is configured to generate a plurality of light fields 190(i) in an entangled state 192. Each light field 190(i) propagates from probe-state generator 110 to a respective sensor module 120(i) via a respective propagation channel 194(i). Sensor modules 120 use light fields 190 to conduct a measurement. In the example scenario shown in FIG. 1, sensor modules 120 probe a sample 196 with light fields 190.

When entangled state 192 is successfully distributed to sensor modules 120, such that light fields 190 remain in entangled state 192 after transmission through propagation channels 194, measurements made by sensor modules 120 may benefit from entanglement-based enhancement. However, propagation channels 194 may be lossy. In the absence of some form of loss mitigation, transmission losses in propagation channels 194 will degrade and, in some situations, even destroy the entanglement between light fields 190. Network 100 is configured to mitigate transmission losses in propagation channels 194, so as to facilitate entanglement-based enhancement of measurements made by sensor modules 120. The mitigation is based on two features of network 100: (1) Probe-state generator 110 is configured to prepare entangled state 192 as a continuous-variable entangled state, and (2) a quantum repeater 130 is incorporated in each of one or more of propagation channels 194.

Discrete-variable entangled light fields are highly vulnerable to loss. Loss of just a few photons from light fields in a discrete-variable entangled state may destroy the entanglement completely. In other words, the effect of loss on a discrete-variable entangled state tends to be catastrophic, and loss mitigation does not appear to be possible. Continuous-variable entangled state 192, on the other hand, degrades only gradually in the presence of loss. The no-cloning theorem prevents a quantum state of light from being deterministically amplified without introducing noise. Therefore, each quantum repeater 130 is configured to amplify the respective light field 190 in a non-deterministic manner. That is, the amplification imposed by quantum repeater 130 has a less-than-unity success probability.

In one embodiment, every propagation channel 194 has a quantum repeater 130. In certain other embodiments, only propagation channels 194 most subject to loss are equipped with a quantum repeater 130. In one such embodiment, one or more sensor modules 120 are located close to probe-state generator 110 and not subject to significant transmission losses, whereas one or more other sensor modules 120 are more distant from probe-state generator 110 and subject to significant transmission losses. In this embodiment (not illustrated), only propagation channels 194 to the more distant sensor modules 120 are equipped with a quantum repeater 130.

Each sensor module 120(i) may include a detector 122(i) that detects a field displacement of light field 190(i), for example imposed by sample 196. Detector 122 may be a homodyne detector. Without departing from the scope hereof, the launching point of light field 190(i) toward sample 196 from an output end of propagation channel 194(i) may be in a different location than the corresponding detector 122(i). In one example of such a scenario, light fields 190(i) are launched on one side of sample 196 and detected by detectors 122(i) on another side of sample 196 after passing through sample 196.

FIG. 2 illustrates one probe-state generator 200 for generating light fields 190(i), i=1, M, in continuous-variable entangled state 192. Probe-state generator 200 is an embodiment of probe-state generator 110. Probe-state generator 200 includes a beam splitter network 210 that mixes a squeezed vacuum state 290 with M−1 vacuum states 292 to produce the M light fields 190(i) in entangled state 192. Beam splitter network 210 may be lossless. In one embodiment, beam splitter network 210 is a balanced beam splitter network. Without departing from the scope hereof, beam splitter network may receive multiple squeezed vacuum states, as opposed to just the single squeezed vacuum state depicted in FIG. 2, as input.

In one embodiment, beam splitter network 210 is an M×M beam splitter network, for example as disclosed by Clements et al. in “Optimal design for universal multiport Interferometers”, Optica, Vol. 3, No. 12, 2016, pp. 1460-1465, which is incorporated herein by reference in its entirety.

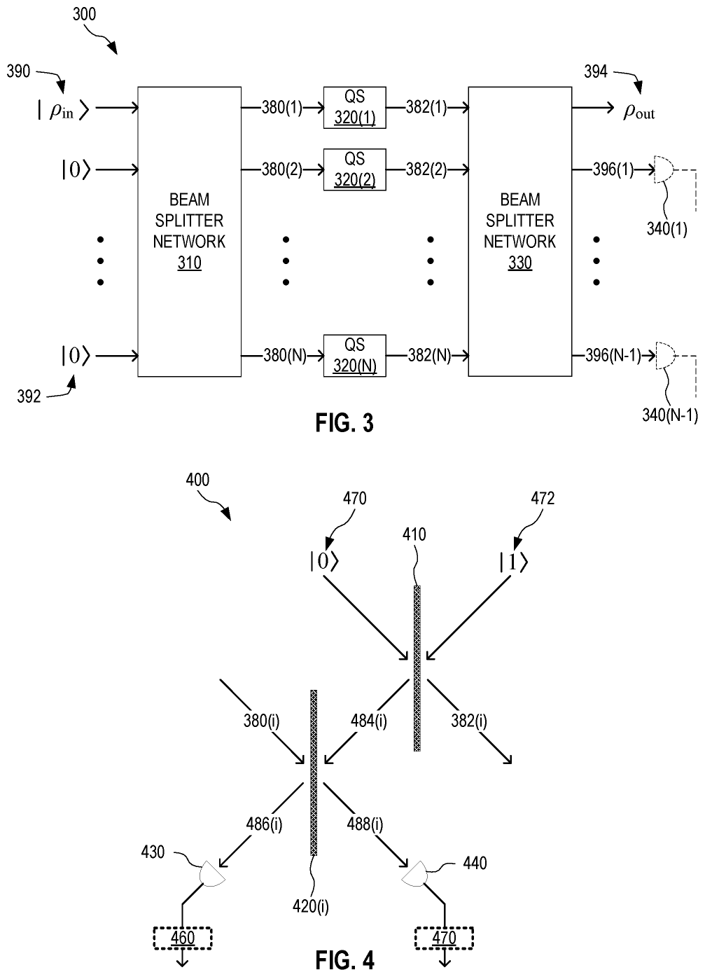

FIG. 3 illustrates one quantum-scissor based quantum repeater 300 for non-deterministic linear amplification of a light field. Quantum repeater 300 is an embodiment of quantum repeater 130. Quantum repeater 300 includes beam splitter networks 310 and 330, and N quantum scissors 320, wherein N is an integer greater than one. Beam splitter network 310 is a balanced N×N beam splitter network that mixes a light field 190 (e.g., light field 190 received by quantum repeater 130) with N−1 vacuum states 392 to divide light field 190 into N weaker light fields 380. Each light field 380(i) is individually amplified, with less-than-unity success probability, by quantum scissor 320(i) to produce a light field 382(i). Beam splitter network 330 combines light fields 382 to output a light field 394 (e.g., light field 190 processed by quantum repeater 130) and N−1 auxiliary output states 396. If all quantum scissors 320 have successfully amplified the respective light field 380 and all N−1 auxiliary output states 396 are vacuum states, light field 394 is an amplification of light field 390.

To determine whether or not amplification is successful, quantum repeater 300 may direct each of auxiliary output states 396(i) to a corresponding single-photon detector 340(i), and quantum scissors 320 may be equipped with single-photon detectors (not shown in FIG. 3) to detect auxiliary outputs therefrom.

In one embodiment, beam splitter network 310 is an N×N network of beam splitters, as disclosed by Clements et al. in “Optimal design for universal multiport Interferometers”, Optica, Vol. 3, No. 12, 2016, pp. 1460-1465, with each beam splitter configured with a 50/50 beam splitter ratio.

FIG. 4 illustrates one quantum scissor 400 for non-deterministic amplification of light field 380(i). Quantum scissor 400 is an embodiment of quantum scissor 320 and includes a beam splitter 410 having transmissivity γ, a balanced beam splitter 420, and two single-photon detectors 430 and 440. Beam splitter 410 is configured to receive a vacuum state 470 and an auxiliary single-photon state 472 at the two input ports of beam splitter 410, and output light field 382 and light field 484 at the two output ports of beam splitter 410. Beam splitter 420 receives light field 380 and light field 484 at the two input ports of beam splitter 420, and outputs light fields 486 and 488 at the two output ports of beam splitter 420. Light fields 486 and 488 are directed to single-photon detectors 430 and 440, respectively. Amplification by quantum scissor 400 is successful when either of single-photon detectors 430 and 440 registers a click. When the amplification is successful, quantum scissor 400 amplifies light field 380 by a factor of g=\sqrt{(1−γ)/γ}, such that light field 382 is light field 380 multiplied by g.

In an embodiment of quantum repeater 300 that implements each quantum scissor 320 as a quantum scissor 400, amplification by quantum repeater 300 is successful when (a) in each quantum scissor 400, either of single-photon detectors 430 and 440 registers a click, and (b) none of single-photon detectors 340 registers a click. In the ideal case of infinitely many quantum scissors 400 in quantum repeater 300, i.e., N=∞, successful amplification by quantum repeater 300 amounts to noiselessly amplification of light field 390 by a factor of g. This ideal system with N=∞ has a zero success probability, rendering the system both impractical and unphysical. However, as discussed further in Appendix A attached hereto, we have found that embodiments of quantum repeater 300 implementing a finite number of quantum scissors 400 are beneficial at least under some circumstances. A quantum repeater 300 with a finite number of quantum scissors 400 has a non-zero success probability at the cost of introducing some noise. We have found that an example with N=2 (i.e., two quantum scissors 400) provides measurement enhancement in some scenarios.

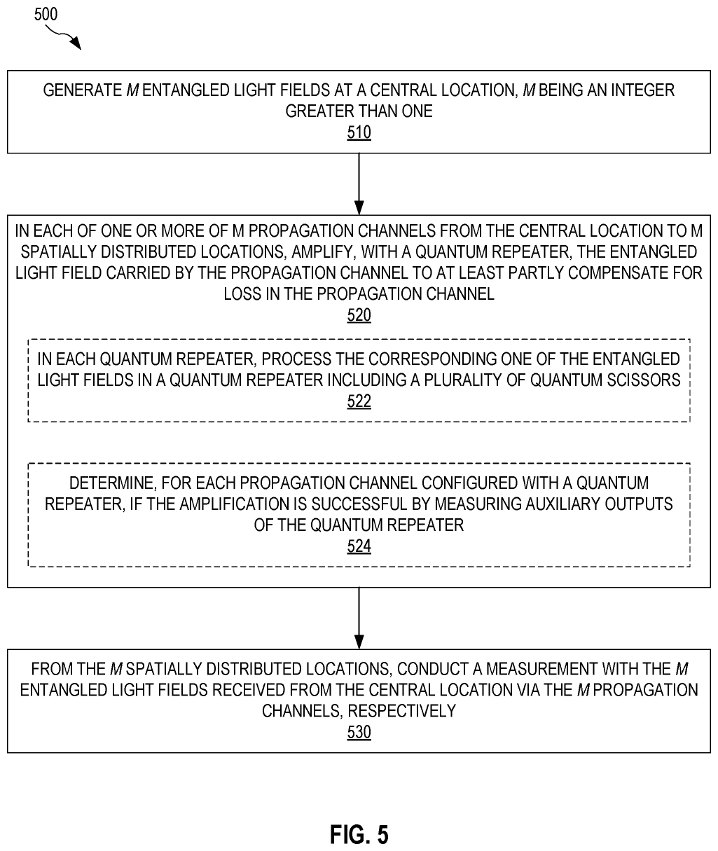

FIG. 5 illustrates one method 500 for spatially distributed quantum sensing enhanced by quantum repeaters. Method 500 may be performed by network 100. Method 500 includes sequential steps 510, 520, and 530. Step 510 generates M entangled light fields at a central location, wherein M is an integer greater than one. In one example of step 510, probe-state generator 110 generates light fields 190 in entangled state 192. Step 530 conducts, from M spatially distributed locations, a measurement with the M entangled light fields received from the central location via M propagation channels, respectively. In one example of step 530, sensor modules 120 use respective light fields 190 to conduct measurements, such as probing of sample 196. Step 520 serves to mitigate loss in each of one or more of the propagation channels by amplifying, with a quantum repeater and with less-than-unity success probability, the entangled light field carried by the propagation channel. In one example of step 520, each of one or more quantum repeaters 130 amplifies a respective light field 190 at less-than-unity success probability.

Step 520 may include a step 522 of, in each quantum repeater, processing the corresponding one of the entangled light fields in a quantum repeater including a plurality of quantum scissors. In one example of step 522, each quantum repeater is quantum repeater 300, for example implementing two or more quantum scissors 400. Step 520 may further include a step 524 of determining, for each propagation channel configured with a quantum repeater, if the amplification is successful by measuring auxiliary outputs of the quantum repeater. In one example of step 524, single-photon detectors 430, 440, and 340, of an embodiment of quantum repeater 300 implementing two or more quantum scissors 400, measure auxiliary light fields (as indicated in FIGS. 3 and 4) to determine if amplification by quantum repeater 300 is successful.

Changes may be made in the above systems and methods without departing from the scope hereof. It should thus be noted that the matter contained in the above description and shown in the accompanying drawings should be interpreted as illustrative and not in a limiting sense. The following claims are intended to cover generic and specific features described herein, as well as all statements of the scope of the present systems and methods, which, as a matter of language, might be said to fall therebetween.

What is claimed is:

1. An entangled, spatially distributed, quantum sensor network enhanced by quantum repeaters, comprising:
a probe-state generator configured to generate M entangled light fields, M being an integer greater than one;
M spatially distributed sensor modules communicatively coupled with the probe-state generator to receive the M entangled light fields, respectively, and conduct a measurement therewith; and
one or more quantum repeaters, each (a) located in a propagation channel of a respective one of the entangled light fields to its corresponding sensor module from the probe-state generator, and (b) including a plurality of quantum scissors to amplify the entangled light field to at least partly compensate for loss in the propagation channel.

2. The quantum sensor network of claim 1, the entangled light fields being in a continuous-variable entangled state.

3. The quantum sensor network of claim 1, the probe-state generator including a beam splitter network configured to produce the M entangled light fields by mixing a squeezed vacuum state with M−1 vacuum modes.

4. The quantum sensor network of claim 3, the beam splitter network being a balanced beam splitter network.

5. The quantum sensor network of claim 1, each of the sensor modules including a homodyne detector for measuring a field displacement of the corresponding entangled light field imposed by probing a sample.

6. The quantum sensor network of claim 1, the one or more quantum repeaters being M quantum repeaters respectively configured to amplify the M entangled light fields.

7. The quantum sensor network of claim 1, each of the quantum repeaters having exactly two quantum scissors.

8. The quantum sensor network of claim 1, each of the one or more quantum repeaters including:
N quantum scissors;
a first balanced beam splitter network configured to mix the corresponding entangled light field with N−1 vacuum states to produce N intermediate light fields to be processed by the N quantum scissors, respectively; and
a second balanced beam splitter network configured to combine the N intermediate light fields, after processing by the quantum scissors, to produce an output light field.

9. A method for spatially distributed quantum sensing enhanced by quantum repeaters, comprising:
generating M entangled light fields at a central location, M being an integer greater than one;
conducting, from M spatially distributed locations, a measurement with the M entangled light fields received from the central location via M propagation channels, respectively; and
amplifying, in each of one or more of the propagation channels and with a quantum repeater, the entangled light field carried by the propagation channel to at least partly compensate for loss in the propagation channel.

10. The method of claim 9, wherein:
said amplifying comprises processing, with a plurality of quantum scissors, the corresponding one of the entangled light fields in a quantum repeater; and
the method further includes determining, for each propagation channel configured with a quantum repeater, if said amplifying is successful by measuring auxiliary outputs of the quantum repeater.
